(19) United States
(12) Patent Application Publication
(10) Pub. No.: US 2004/0237654 A1
(43) Pub. Date: Dec. 2, 2004

(54) Method and device for controlling the integrity of membrane filtration units

(76) Inventors: Vincent Savall, Velizy-Villacoubly (FR); Jean-Pierre Roux, Saint-Graitien (FR)

Correspondence Address: CONNOLLY BOVE LODGE & HUTZ LLP, SUITE 800, 1990 M STREET NW, WASHINGTON, DC, 20036-3425, US

(21) Appl. No.: 10/484,887

(22) PCT Filed: Jul. 3, 2002
(86) PCT No.: PCT/FR02/02323

(30) Foreign Application Priority Data
Aug. 6, 2001 (FR) 01/10513

(51) Int. Cl. G01N 29/14

(52) U.S. Cl. 73/592; 73/579; 73/40.5 A; 73/587

(57) ABSTRACT

The invention relates to a method of controlling the integrity of hollow fibre filtration units and of detecting leaks through a wholly or partially ruptured fibre. The inventive method is characterised in that it consists in: —emitting a noise or audible signal using an emitter located on one side of the membranes of the filtration units; —detecting the noise or audible signal emerging from a ruptured fibre on the other side of the membranes, regardless of whether or not a fluid is passing through said fibre; —amplifying the signal-noise thus obtained; —and comparing the resulting amplified signal to a threshold noise level in the same frequency range.

The present invention relates both to a method and a device intended for checking the integrity of microfiltration or ultrafiltration modules that are used in processes for the separation and concentration of solutions, and especially in the water treatment field.

It is known that such modules employ a plurality of hollow fibres grouped together in bundles, and the problem that the present invention aims to solve is that of detecting a fibre breakage, which is manifested by the fluid passing directly from the dirty (concentrate) side to the clean (permeate) side of the membrane, through the completely or partially broken fibre or fibres.

FR-A-2 775 440 and WO 99/44728 provide a solution to this problem by means of a method that relies on detecting the noise emitted by the turbulence of the fluid passing through a broken fibre. According to the above prior art, this method consists in:

detecting the noise brought about by the fluid passing through a broken fibre;

amplifying the noise signal thus obtained; and

comparing the amplified signal thus obtained with a threshold noise level, within the same frequency range, characteristic of integral modules, this comparison making it possible to detect whether the module is integral or not.

This prior art also discloses a device for implementing this method, which comprises:

a hydrophone mounted on the bottom purge of each module;

an amplifier that amplifies the signals delivered by this hydrophone; and

a comparator-analyser for comparing the noise signal picked up and amplified with a threshold noise level characteristic of an integral module, analysis of the comparison making it possible to detect the possible presence of a leak in the module.

This known technique is generally satisfactory. However, on an industrial scale it turns out that the output level of the noise produced by the breakage of a fibre may be too low: it therefore remains mixed with the parasitic noise, whether the latter noise is of hydraulic, mechanical or other origin, from the industrial unit in which the hollow-fibre modules are employed. The above noise, that has to indicate the presence of a possible leak, is therefore not clearly detected.

To solve the abovementioned problem, the invention provides a method for checking the integrity of hollow-fibre filtration modules and for detecting leaks through a completely or partially broken fibre, characterized in that it consists in:

emitting a noise or acoustic signal by means of an emitter located on one side of the membranes of the filtration modules;

detecting, on the other side of the membranes, the noise or acoustic signal coming from a broken fibre, whether or not the said fibre is exposed to a fluid flow;

amplifying the noise signal thus obtained; and

comparing the resulting amplified signal with a threshold noise level, within the same frequency range.

It will be understood that this comparison makes it possible to detect whether the module is integral or not.

According to the invention, the said noise or acoustic signal is emitted either within a frequency band different from the parasitic noise or at a higher acoustic pressure level.

Integral modules prove to be an excellent acoustic screen and the signal detected downstream of such modules is weak; in contrast, in the event of complete or partial breakage of a fibre, the signal detected downstream is much stronger.

The aim of the invention is also to provide a device for implementing the method as defined above. This device is produced in accordance with that disclosed in the abovementioned prior art, but it also includes at least one acoustic emitter for a number of modules, which emits a specific signal either within a frequency band different from the parasitic noise or at a higher power level, this or these acoustic emitters being positioned on the opposite side of the modules to that on which the hydrophones lie.

Other features and advantages of the present invention will become apparent from the description given below with reference to the appended drawings, which illustrate an example of the implementation of the invention, this being devoid of any limiting character.

In the figures:

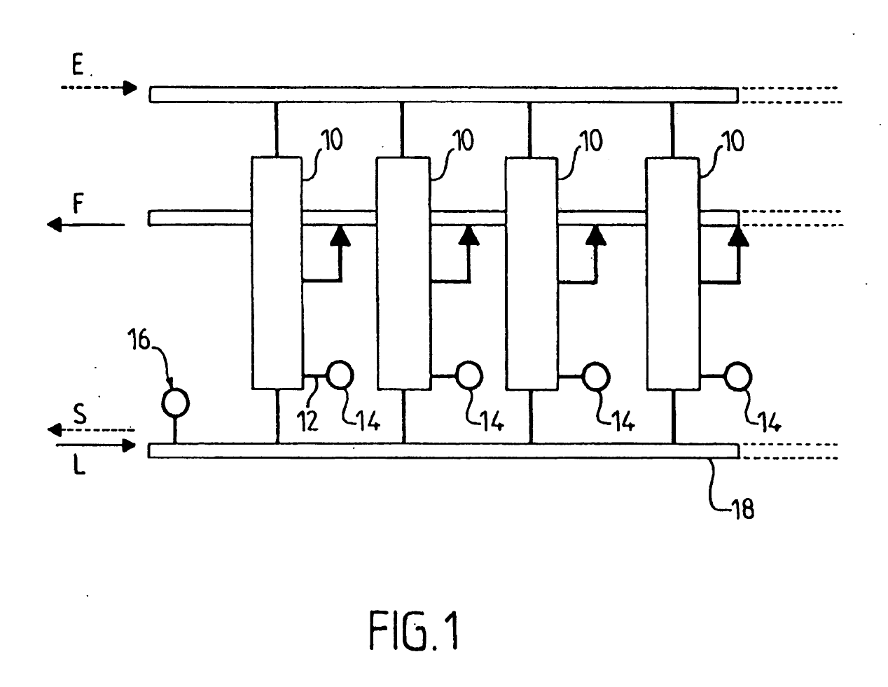

FIG. 1 is a schematic representation of one embodiment of the device according to the invention; and

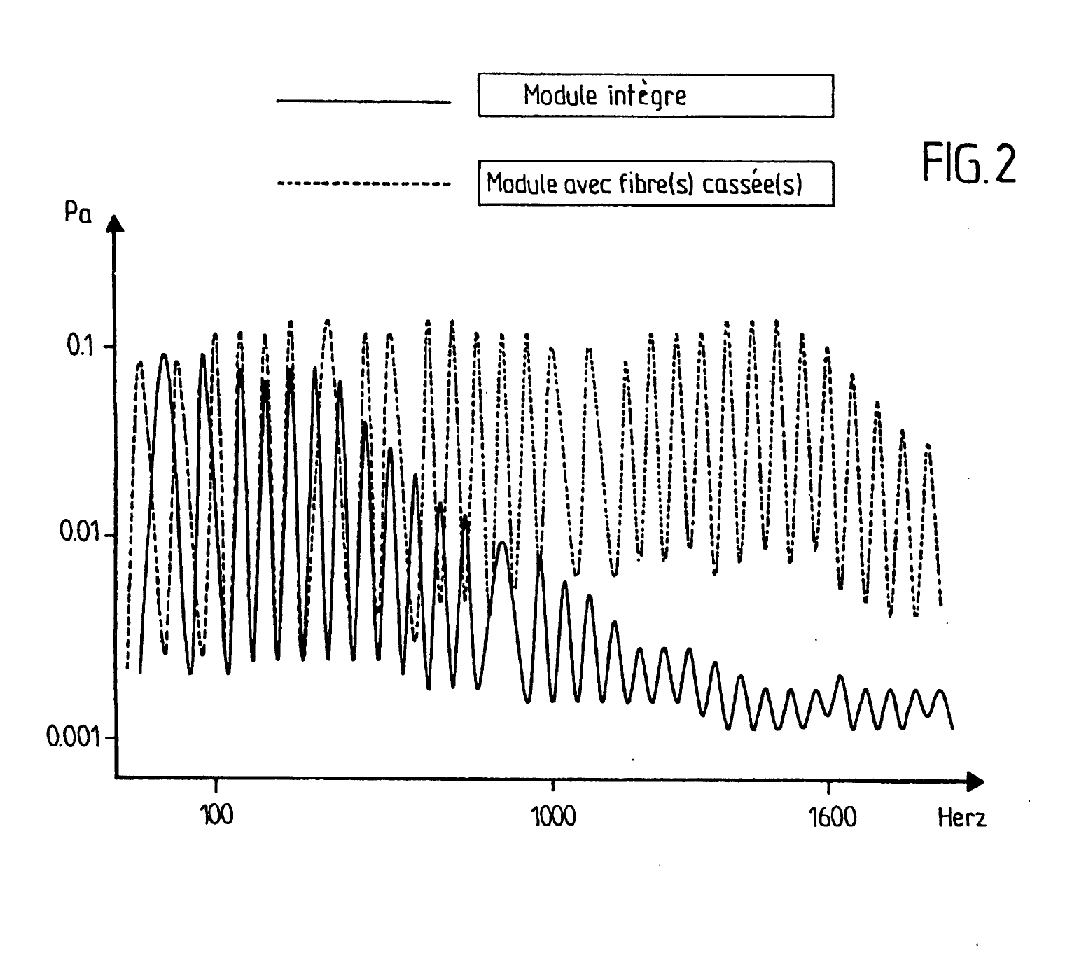

FIG. 2 shows the curves that illustrate the acoustic signal of, on the one hand, an integral module and, on the other hand, a module with a broken fibre.

FIG. 1 illustrates the device in a non-limiting implementation example in which the modules are in a housing, filtering from the inside of the fibres to the outside.

In this FIG. 1, the reference 10 denotes the filtration modules of the type comprising a plurality of hollow fibres grouped into bundles. In accordance with the prior art, a hydrophone 14 has been fitted to the bottom purge 12 of each module 10, this hydrophone being in contact with the clean water (permeate), allowing the noise of fluid flow to be picked up directly.

According to the invention, an acoustic emitter 16 is placed on the inlet header 18 for the liquid to be filtered (arrow L) in transverse flow mode, the arrow F denoting the filtered liquid.

In tangential flow mode, the acoustic emitter 16 is placed on the outlet of the recirculation loop. In FIG. 1, the arrow S denotes this outlet of the recirculation loop, the inlet of this loop in tangential mode being denoted by the arrow E.

It should be pointed out that the hydrophones 14 equipping each module 10 are placed on the opposite side of the membrane to that on which the emitter 16 lies.

Since the damping of the acoustic signal emitted by the emitter 16 by integral membranes is very much greater than that emitted by a module having at least one broken fibre, the acoustic level detected by a hydrophone, such as 14, after processing (amplification and analysis), can be used to trigger an alarm should the integrity of the module in question be broken.

For this purpose, the device may furthermore include a programmable controller that receives the emitted signal and manages the operation of the system of filtration modules, for the purpose of retransmitting the signal either to a centralized system in the plant or to an operator some distance away.

It should be noted that the invention may be applied to all types of hollow-fibre filtration membranes (filtering from the inside outwards or from the outside inwards) and optionally flat membranes. In the use with other membrane types, the arrangement of the emitters and of the hydrophones may differ from that described above, however the essential point is that the hydrophones are not placed on the same side of the membrane as the emitter(s).

According to the invention, the detection may be performed in filtration mode, in backwash mode or in “plant shutdown” mode.

Tests carried out on a specially adapted platform have shown significant differences between the emitted noise level and the noise detected by the hydrophones. In FIG. 2, curve A illustrates the acoustic level obtained on a module having a broken fibre and curve B illustrates the acoustic level obtained on an integral module. It may be seen that the damping of the acoustic signal, emitted by the acoustic emitter 16, by an integral membrane is very much greater than that of a module having at least one broken fibre.

The advantages and technical improvements provided by the invention are in particular the following:

the possibility of detection whatever the filtration flow rate, or even in a period of stoppage;

the possibility of detection in quasi-continuous mode, by successively listening to all the modules of an array, each of them being provided with a hydrophone, this detection not requiring production to be stopped; and

since the emitted signal is transmitted to a programmable controller managing the operation of the membrane filtration system, it can therefore be retransmitted to a centralized system in the plant or to an operator some distance away, who is responsible for deciding on the possible corrective actions to be undertaken.

Of course, the fact remains that the present invention is not limited to the implementation examples described and shown above, rather it encompasses all variants thereof.

1-9. (Canceled).

10. Method for checking the integrity of hollow-fibre filtration modules and for detecting leaks through a at list partially broken fibre, comprising the steps of:
emitting an acoustic signal by means of an emitter located on one side of the membranes of the filtration modules;
detecting, on the other side of the membranes, the acoustic signal coming from a broken fibre, whether or not the said fibre is exposed to a fluid flow;
amplifying the acoustic signal this obtained; and
comparing the resulting amplified signal with a threshold acoustic level, within the same frequency range.

11. Method according to claim 10, wherein said acoustic signal is emitted within a frequency band different from the parasitic noise.

12. Method according to claim 10, wherein said acoustic signal is emitted within a frequency band at an acoustic pressure level higher that the level of said parasitic noise.

13. Method according to claim 10, wherein the detection is performed in filtration mode.

14. Method according to claim 10, wherein the detection is performed in backwash mode.

15. Method according to claim 10, wherein the detection is performed in “plant shutdown” mode.

16. Device for checking the integrity of hollow-fibre filtration modules using the method according to claim 1, comprising:
a hydrophone mounted on the bottom purge of each module in order to detect the noise generated by the fluid passing through a broken fibre;
an amplifier that amplifies the signals emitted by the said hydrophones; and
a comparator-analyzer for comparing the noise signal picked up and amplified with a threshold noise level characteristic of an integral module, analysis of the comparison making it possible to detect the possible presence of a leak in the module,
at least one acoustic emitter, for a number of modules, which emits a specific signal either within a frequency band different from the parasitic noise or at a higher power level, the said acoustic emitter being positioned on the opposite side of the modules to that on which the hydrophones lie.

17. Device according to claim 16, wherein the acoustic emitter or emitters are placed on the inlet header for the water to be filtered, in transverse flow mode.

18. Device according to claim 16, wherein the acoustic emitter or emitters are placed on the outlet of the recirculation loop, in tangential flow mode.

19. Device according to claim 16, further including a programmable controller that receives the emitted signal and manages the operation of the system of filtration modules, for the purpose of retransmitting the signal either to a centralized system in the plant or to an operator some distance away.
